(19) United States
(12) Patent Application Publication
(10) Pub. No.: US 2009/0315287 A1
(43) Pub. Date: Dec. 24, 2009

(54) Mobile Cart

(76) Inventor: Alfred P. Rossini, Southborough, MA (US)

Correspondence Address: MIRICK, O'CONNELL, DEMALLIE & LOUGEE, LLP, 1700 WEST PARK DRIVE, WESTBOROUGH, MA, 01581, US

(21) Appl. No.: 12/418,338

(22) Filed: Apr. 3, 2009

Related U.S. Application Data
(60) Provisional application No. 61/074,170, filed on Jun. 20, 2008.

(51) Int. Cl. B62B 11/00

(52) U.S. Cl. 280/47.35

(57) ABSTRACT

A mobile cart that may be used to carry a computer and/or a secure medication storage compartment. The mobile cart includes a multi-wheeled base, which may include two or more omni-directional, locking swivel casters and one or more non-swiveling, self-leveling wheels. The mobile cart is also height-adjustable. When used as a bedside medication cart, the mobile cart includes an auto-closing and auto-locking medication storage compartment that can be accessed through an electronic password, or manually via a standard key-operated lock. The mobile cart may also include a computer in addition to, or in place of, the medication storage compartment.

### CROSS-REFERENCE TO RELATED APPLICATIONS

This application claims the benefit of priority of U.S. Provisional Patent Application Ser. No. 61/074,170 filed on Jun. 20, 2008, the entire contents of which is expressly incorporated by reference herein.

### FIELD OF THE INVENTION

The invention relates generally to the field of carts, and more specifically, to mobile computer carts and mobile carts used for medication storage and delivery.

### BACKGROUND OF THE INVENTION

With the implementation of strict HIPAA (Health Insurance Portability and Accountability) and JCOAH (Joint Commissions on Accreditation of Healthcare Organizations) requirements at most hospitals, the proper tracking and storage of medications is critical. Unfortunately, however, the healthcare market has not established process standards, and many hospitals have implemented processes that are unrealistic or impossible to enforce, and may also be quite costly to implement.

For example, some hospitals use very large bulk storage or centrally located medication storage systems, such as the PICIS system, which require a nurse to use small plastic bags for each patient's medications. A nurse may need to make several trips back and forth each day to the medication storage system with the patient's chart to get each patient's medication. At the other end of the spectrum, it is not uncommon to have the nursing staff sign out the medication for several patients at once and place the medications in their pockets as they make their way from one patient room to another. While this may save time for the nurse, there is the possibility of delivering the wrong medication to the patient.

There is a need then, for a mobile, secure medication storage and delivery cart to simplify the process of beside medication delivery for multiple patients at once. Ideally, such a cart would have a secure compartment with auto-closing and auto-locking features, and a secure means for unlocking the compartment. In addition, these carts are typically used by many different people over the course of a day or a week, and it is thus important that these carts have certain ergonomic features. For example, it is desirable for the user to be able to adjust the height of the cart to place the work surfaces and secure compartment or drawer and computer keyboard and mouse at a convenient and comfortable position. In addition, a medication storage and delivery cart would need a small footprint to accommodate bedside delivery of medications.

Ergonomic features are also important for mobile computer carts, including those used by the health care market. Many hospitals have converted to paperless processes, which may result in the use of mobile computers for entering and retrieving data. The overall weight of a mobile computer cart, particularly those equipped with a power supply, is an issue for health care administrators. With an average weight of 150 pounds, pushing a mobile cart can be tiring and cumbersome, particularly for smaller users. Many hospitals have reported back issues from users who are required to push a mobile cart all day as part of their job responsibilities.

In the past, mobile carts have been equipped with four swivel casters, which permit the user to maneuver the cart around corners, or push it out of the way if necessary, but makes the cart difficult to steer. In particular, the momentum of the cart may be a problem if the cart is moved quickly, as the cart may become difficult to stop or turn. In addition, the carts are difficult to push in a straight line, as the four swivel casters may cause the cart to move slightly from side to side as it is pushed, especially if the floors are uneven.

The maneuverability of a mobile cart can be improved by making two of the four casters ridged or non-swiveling. In this configuration, the mobile cart operates much like a shopping cart, and the user steers the cart by controlling the front end. This is not ideal, however, because it is still difficult to turn tight corners, and nearly impossible to pivot in place.

There is a need in the art, then, for a mobile cart that is easy to maneuver; a cart that can turn effortlessly and quickly, without a concern that the momentum of the cart will lead the cart astray. In addition, there is a need for a mobile cart that will move in a straight line when pushed, and will self-adjust so that the wheels stay in contact with the floor.

### SUMMARY OF THE INVENTION

The invention provides a mobile cart, and in particular a mobile cart that may be used to carry a computer, monitor or display, a shelf or tray, and/or a secure medication storage compartment. The invention also provides a multi-wheeled base, which may include one or more swiveling wheels and one or more non-swiveling, self-leveling wheels. The mobile cart is also height-adjustable.

When used as a bedside medication cart, the mobile cart of the invention provides an organized approach to medication storage and delivery. The mobile cart of the invention includes an auto-closing and auto-locking medication storage compartment that can be accessed through an electronic password, or manually via a standard key-operated lock. The mobile cart may also include a computer, monitor or display, or a shelf or tray in addition to, or in place of, the medication storage compartment.

The wheeled base may include two or four swiveling, lockable, caster wheels, and may also include one or two non-swiveling, self-leveling wheels, which improve the maneuverability of the cart by making it easier to steer and stop. The self-leveling wheels also serve to keep the cart wheels on the floor.

In preferred embodiments, the invention provides a mobile cart, comprising a rolling base section, an intermediate section that accomplishes a variable length under user control, and an upper working section supported by the intermediate section and comprising a secure storage compartment comprising a normally-locked lid that, when unlocked, must be held open by a user, and when released automatically returns to the closed position and locked state.

In an aspect, the upper working section further comprises an electrically-operated, normally-locked locking mechanism for the lid. In an additional aspect, the locking mechanism is unlocked under computer control. In yet another aspect, the locking mechanism comprises a solenoid. In another aspect, the secure storage compartment further comprises one or more damped cylinders to allow the lid to close gently.

In an aspect, the secure storage compartment comprises a plurality of removable containers. In an additional aspect, the intermediate section comprises an adjustable post. In yet another aspect, the base section comprises a plurality of swiveling wheels and at least one non-swiveling wheel. In a further aspect, the base section is generally rectangular in shape, and one swiveling wheel is located proximate each of the corners of the base section.

In an aspect, the at least one non-swiveling wheel is located on one side of the base section, between two of the swiveling wheels. In another aspect, the at least one non-swiveling wheel is self-leveling. In a further aspect, the cart further comprises a spring assembly removably coupled to the at least one non-swiveling wheel, to accomplish a self-leveling function.

In additional preferred embodiments, the invention provides a cart comprising a base section having a generally rectangular shape and a bottom, a top, a front, a back, and two opposing sides, and comprising four swiveling wheels mounted to the bottom of the base section proximate each of the four corners of the base section and two non-swiveling wheels mounted to the bottom of the base section, proximate the centers of the sides of the base section, and two non-swiveling wheels mounted to the bottom of the base section, each non-swiveling wheel located between two of the swiveling wheels; an intermediate section comprising an adjustable post; and an upper working section supported by the intermediate section.

In an aspect, the upper working section further comprises a locking compartment. In another aspect, the upper working section comprises a secure storage compartment comprising a normally-locked lid that, when unlocked, must be held open by a user, and when released automatically returns to the closed position and locked state. In yet another aspect, the upper working section further comprises an electrically-operated, normally-locked locking mechanism for the lid. In an additional aspect, the locking mechanism is unlocked under computer control.

In additional preferred embodiments, the invention provides a cart comprising a base section having a generally rectangular shape and a bottom, a top, a front, a back, and two opposing sides, and comprising four swiveling wheels mounted to the bottom of the base section proximate each of the four corners of the base section and two non-swiveling wheels mounted to the bottom of the base section, proximate the centers of the sides of the base section, two non-swiveling wheels mounted to the bottom of the base section, each non-swiveling wheel located between two of the swiveling wheels, and a spring assembly removably coupled to the each non-swiveling wheel, to accomplish a self-leveling function; an intermediate section that accomplishes a variable length, under user control; and an upper working section supported by the intermediate section and comprising a secure storage compartment comprising a normally-locked lid that, when unlocked, must be held open by a user, and when released automatically returns to the closed position and locked state, where the locking mechanism is under computer control, and one or more damped cylinders to allow the lid to close gently.

In an aspect, the upper working section further comprises an electrically-operated locking mechanism. In another aspect, the locking mechanism is unlocked under computer control.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of an embodiment of the inventive rolling cart in the lowest position;

FIG. 2 is an exploded view of portions of the upper section of the cart of FIG. 1, including the compartment body of the secure medication storage compartment;

FIG. 3 shows the top for the secure medication storage compartment of FIGS. 1 and 2;

FIG. 4 is a more detailed view of the compartment body of FIG. 2;

FIG. 5 shows the medication tray of the secure medication storage compartment of FIGS. 1-4;

FIGS. 6A-6C are perspective, front and end views, respectively, of portions of the locking assembly for the secure medication storage compartment of FIGS. 1-5;

FIG. 7 is a perspective view of the upper working section of the cart of FIGS. 1-6, with the top in the open position;

FIG. 8 is a view of an alternative embodiment of the rolling base section of the cart of FIG. 1;

FIG. 9 is a rear view of the rolling base section of FIG. 8;

FIG. 10 is a perspective view of the base frame of the base section of FIG. 8;

FIG. 11 is a perspective view of the base frame of FIG. 10, with the addition of swiveling casters;

FIG. 12 is a perspective view of the bottom of the base section of FIG. 8, showing the swiveling casters and the non-swiveling, self-leveling wheels;

FIG. 13 is a perspective view of the base section of FIG. 8, showing the covers for the non-swiveling wheels;

FIG. 14 is an exploded view of the left side non-swiveling wheel assembly of the base section of FIG. 8; and

FIG. 15 is an exploded view of the right side non-swiveling wheel assembly of the base section of FIG. 8.

### DETAILED DESCRIPTION OF THE INVENTION

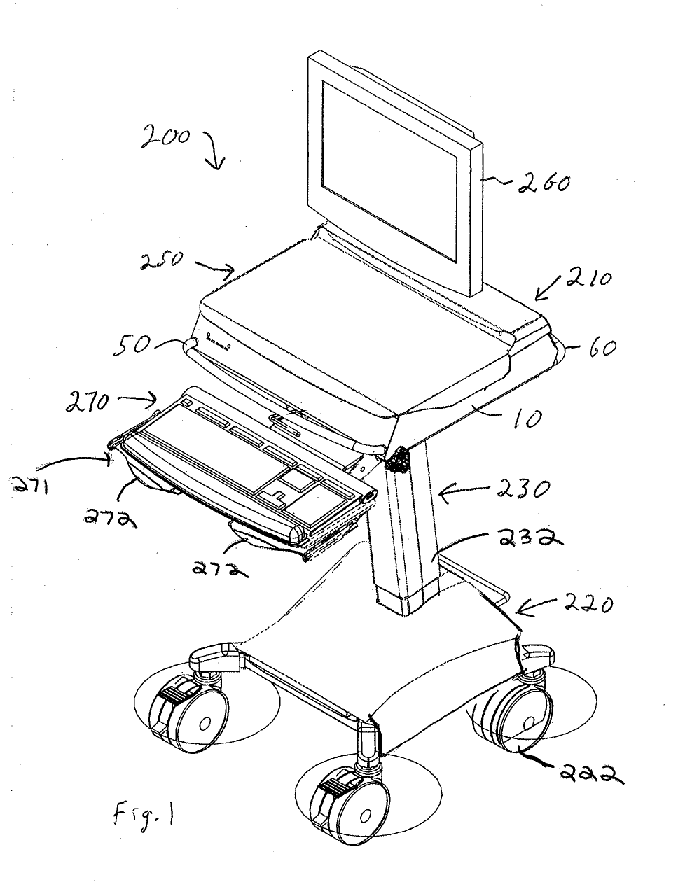

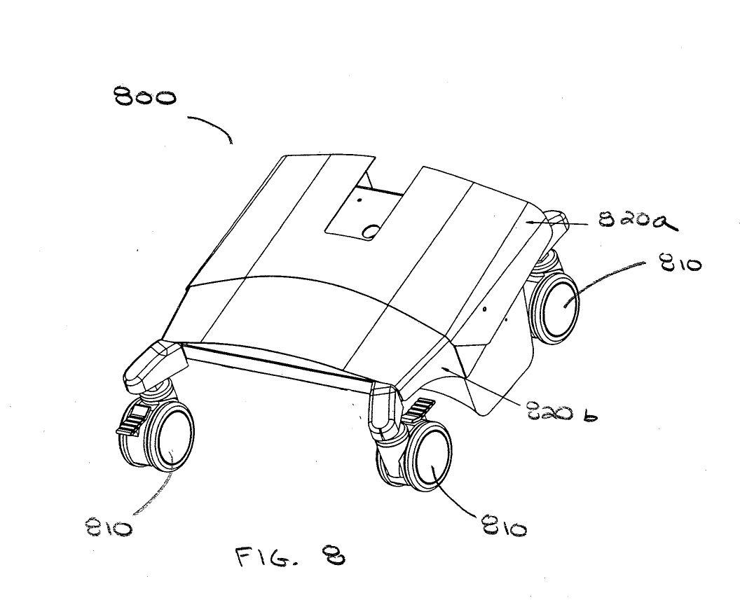

A preferred embodiment of the bedside medication delivery cart of the invention is shown in FIGS. 1-7. Cart 200, as shown in FIG. 1, comprises rolling base section 220, upper working section 210, and intermediate section 230. Intermediate section 230 comprises a length-adjustable upwardly-extending post 232. Base section 220 and intermediate section 230 can take different forms than shown, as long as they allow the cart 200 to be rolled, and the height of the upper working section 210 to be adjusted, either manually or otherwise. In one embodiment, and as shown in FIG. 1, base section 220 includes four locking swiveling casters 222. In alternate embodiments, as shown in FIGS. 8-15 and described below, base section 220 may also include one or two non-swiveling, self-leveling wheels to allow the cart to move in a straight line when pushed, and adjust to different floor conditions.

With further reference to FIG. 1, in a preferred embodiment, upper working section 210 includes keyboard support 271 and keyboard 270, and one or two retractable mouse trays 272. This arrangement allows user input to a computer (not shown) that is typically carried by the cart, for example by a bracket coupled to upper working section 230. Computer display 260 is also provided. Upper working section 210 further includes secure medication storage compartment 250 having a compartment body 10, the construction and functionality of which is further described below. Front projecting handle 50 and rear projecting handle 60 are included to allow the user to easily roll the cart. In alternate embodiments, the mobile cart of the invention may not include a secure medication storage compartment, and upper working section 210 may comprise one or more trays or shelves, and/or may support a monitor or display or computer.

One of the functional aims of intermediate section 230 is to allow the user to relatively easily move the upper working section 210 between the lowest and highest positions, and any location between the two, and maintain the upper working section 210 at the selected height. The post 232 is designed such that the user can accomplish this by squeezing and holding a front release lever (not shown) that is located near the center of front handle 50. The operation of the height adjustment can be accomplished in various manners, but does not form part of the invention and so will not be further described herein. In alternate embodiments, intermediate section 230 may have a fixed position and a fixed height.

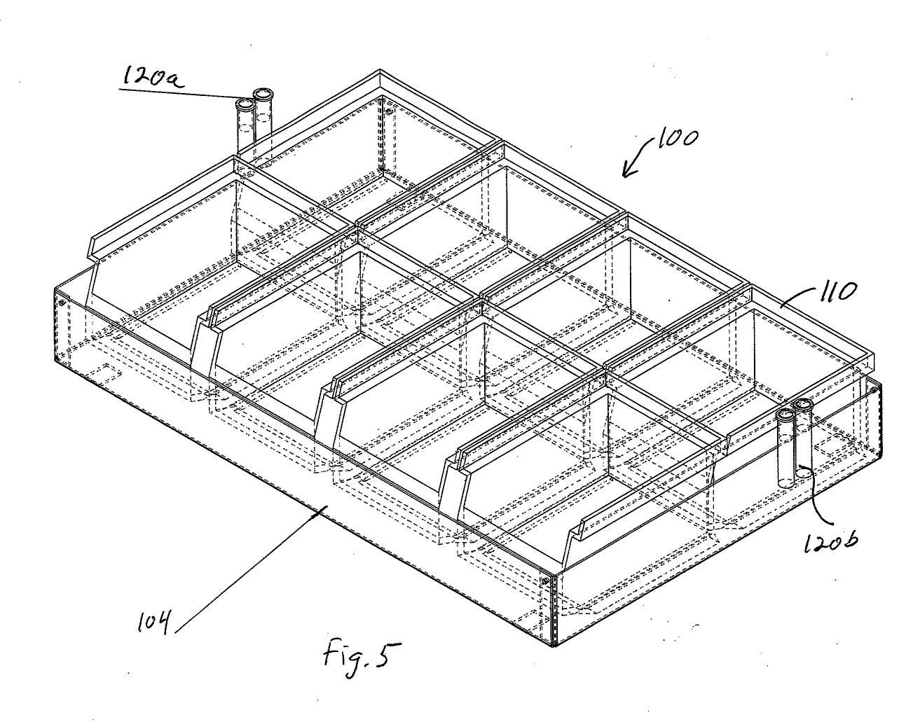

Secure medication storage compartment 250 allows medical personnel to securely store and easily transport medications for several patients from room to room. As shown in FIG. 5, the medications are stored in open-top removable containers or bins 110. In this embodiment, ten bins 110 fit into medication tray body 104 of medication tray 100. Bins are not required, and, when used, there is no set quantity or configuration of bins that can be used in the inventive cart.

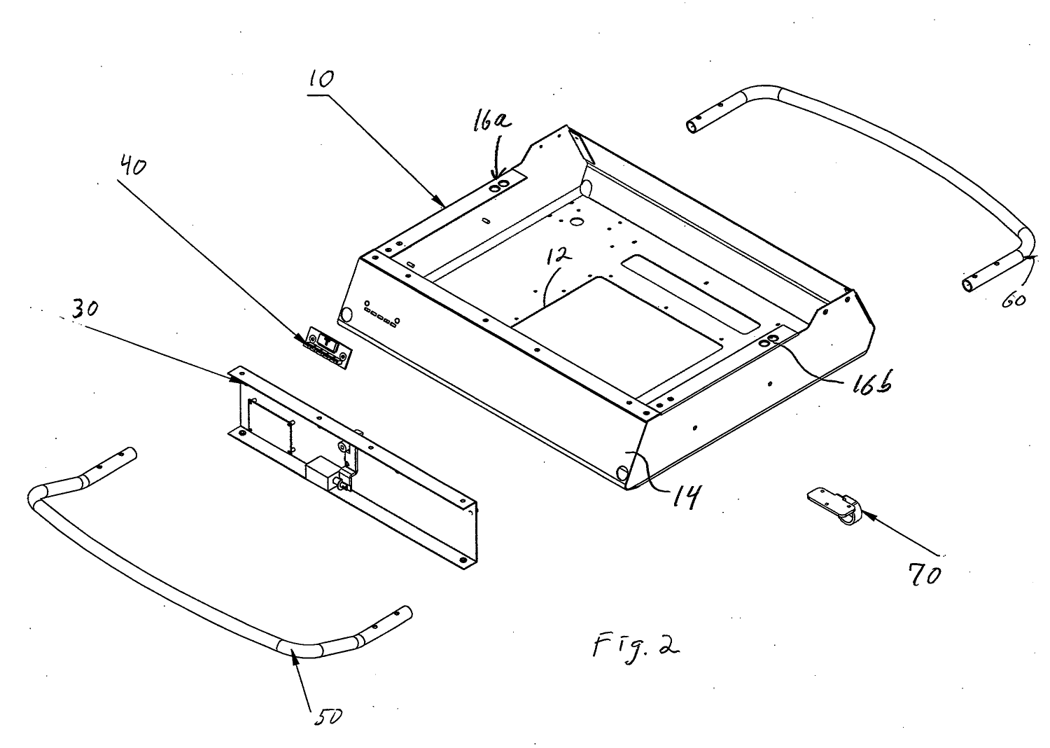

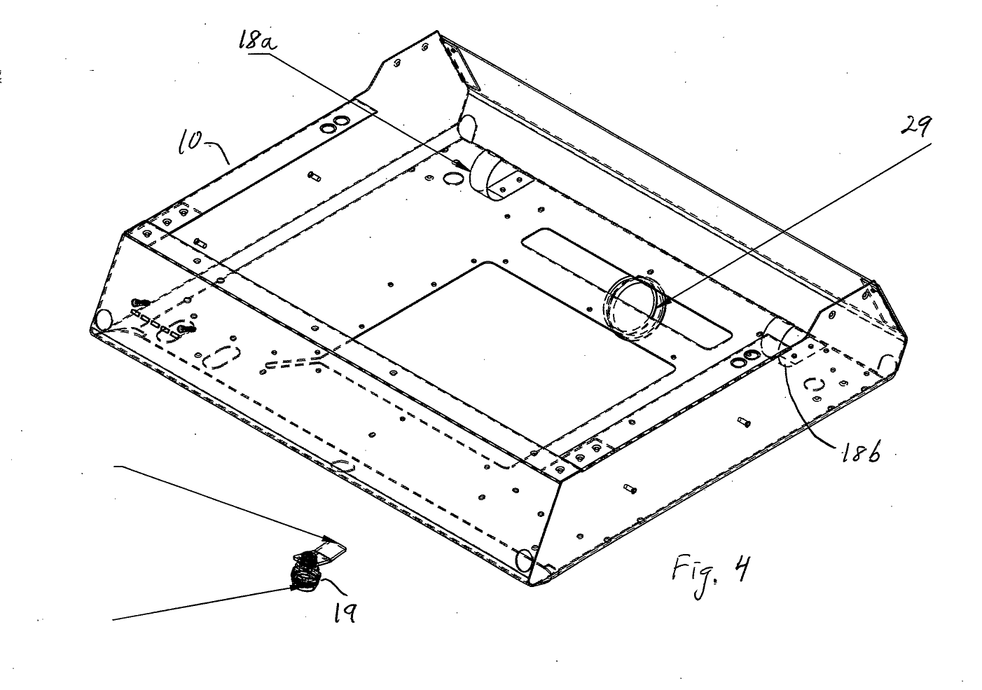

With reference to FIGS. 1, 2, 3, and 5 compartment body 10 of storage compartment 250 has front panel 14 and openings 16a and 16b for damped cylinders 120a and 120b, respectively, which allow hinged top 20 to close gently. When top 20 is open, it must be held open by the user to remain open, and will return automatically to the closed and locked position when released. When top 20 is released, it pivots about a rear hinge (not shown) that is coupled to rear flange 26 and impacts cylinders 120a and 120b, which then slowly compress under the weight of the top so that the last portion of the top's closing motion is damped. With reference to FIG. 2, compartment body 10 may also include an opening 12 that may be used for cable storage, and a power cord catch 70 that may be used to hold the plug end of a power cord when the on-board power supply or battery is not being recharged. With reference to FIG. 4, an opening encircled by a grommet, preferably plastic, 29 may be provided for routing cables into upper working section 210.

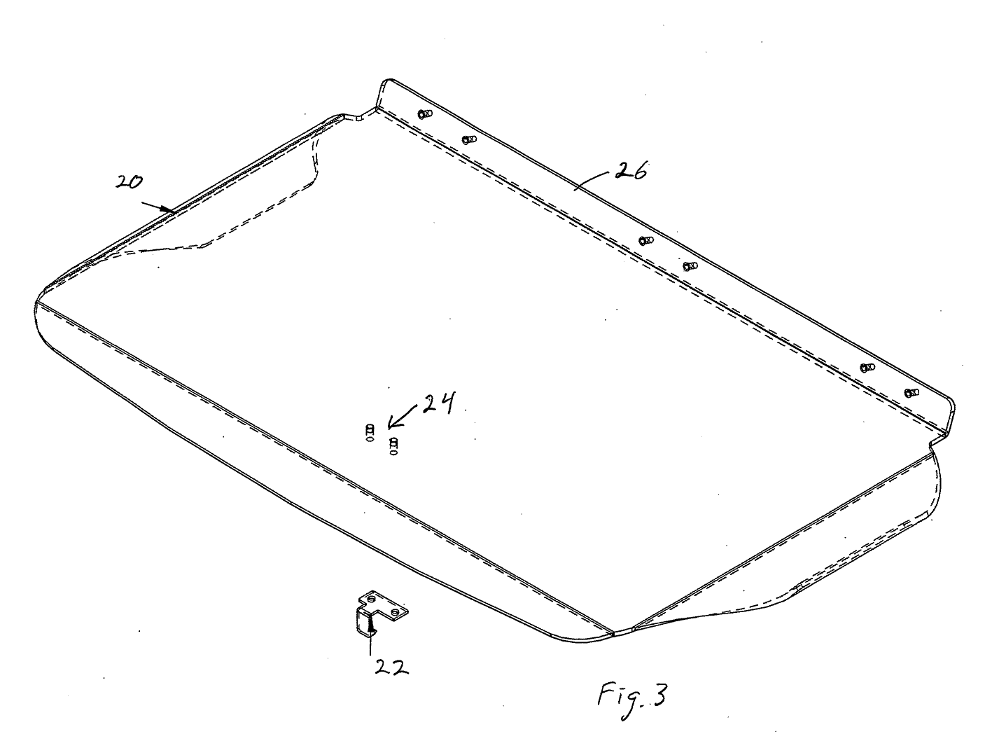

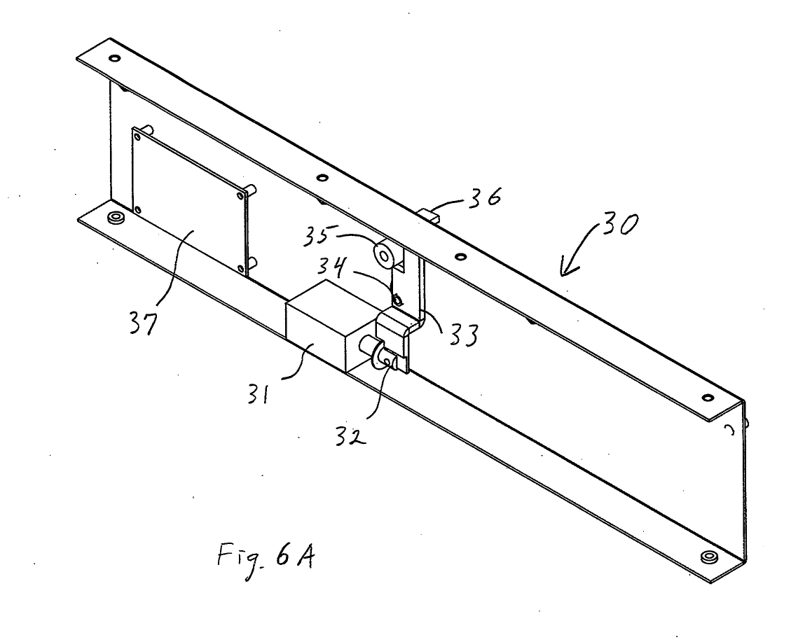

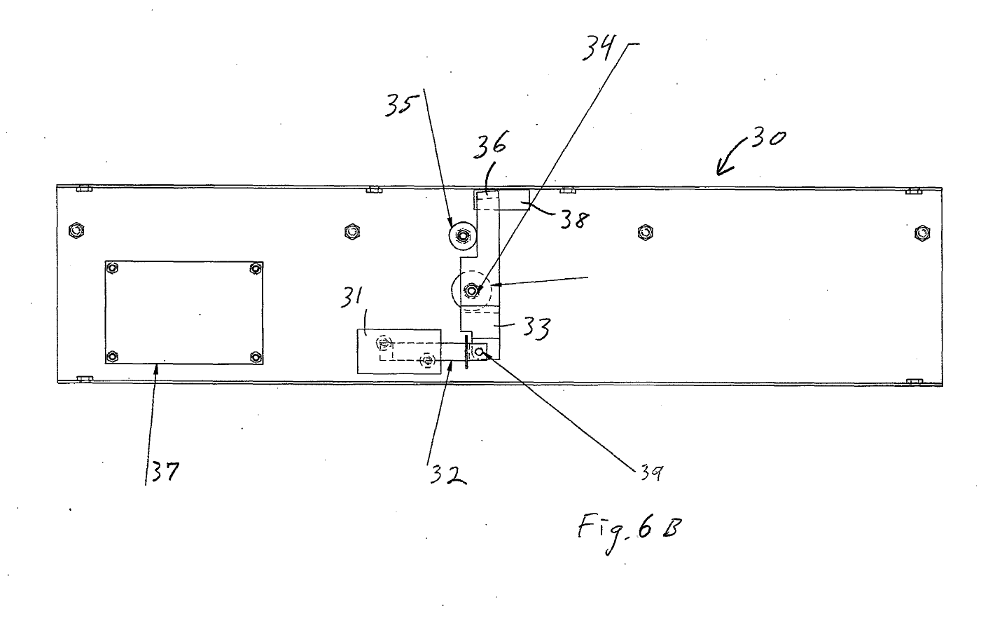

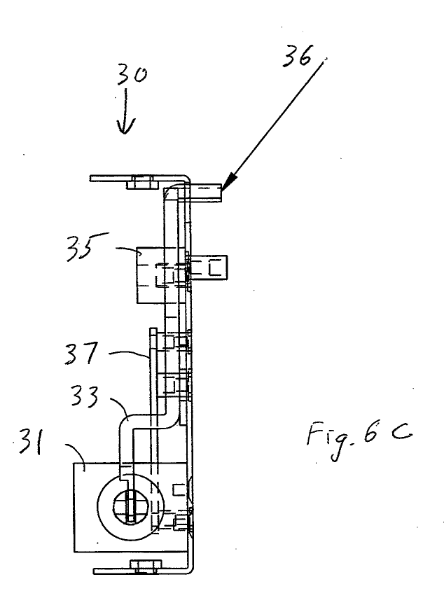

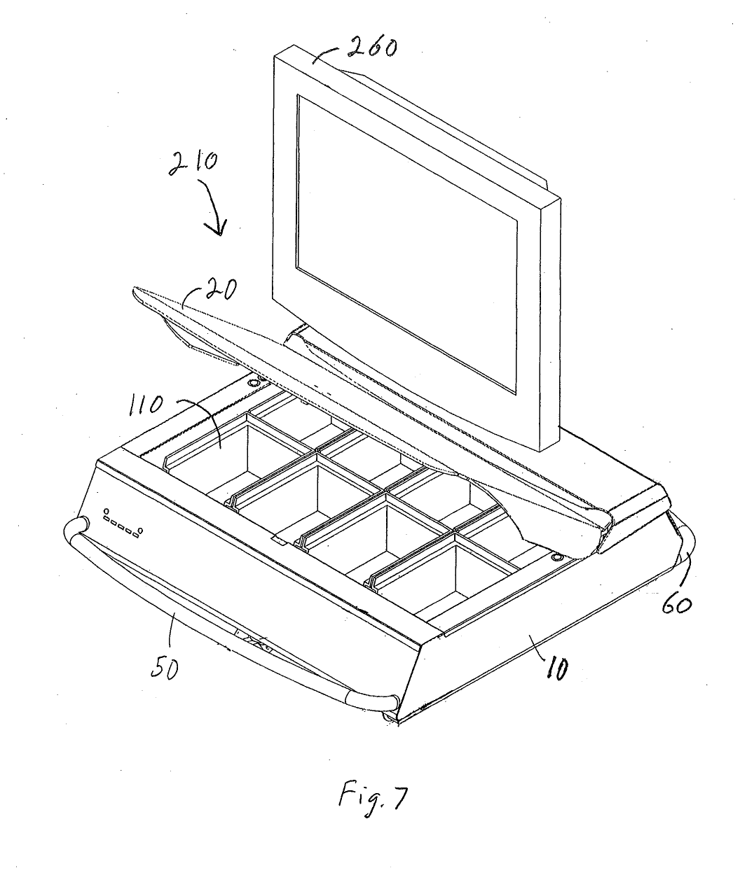

Top 20 is automatically locked when it moves from the open position shown in FIG. 7 to the closed position shown in FIG. 1. With reference to FIGS. 2, 6A, 6B and 6C, this is accomplished with a normally-locked locking assembly that is carried by bracket 30 which is coupled to front panel 14. The locking assembly comprises movable catch 36 that sits underneath top fixed locking catch 22, shown in FIG. 3, when the top is locked. Catch 22 is coupled to top 20 through mounting holes 24. Top 20 is unlocked so that it can be manually lifted to expose tray 100, as follows.

With reference to FIGS. 6A, 6B and 6C, electrically operated solenoid 31 has two stable positions, corresponding to the locked and unlocked states of the top 20. Solenoid 31 pushes actuator 32, which pivots arm 33 about pivot points 34 and 39. This causes catch 36 to move laterally within slot 38, to release catch 36 from being directly below fixed catch 22. Top 20 can then be lifted. Also shown in FIGS. 6A, 6B and 6C is bushing 35, which is used to help dampen the sound of arm 33 when it snaps back to the locked position.

With reference to FIG. 4, manual locking control is provided by standard key-operated lock 19 with a projection that engages with catch 36. This allows access or locking should the computer control malfunction. Manual control may be limited to supervisors, so that the computer can accurately monitor the solenoid operation and thus the user-actuated locking/unlocking actions. Also shown in FIG. 4 are spring bumpers 18a and 18b, preferably made of steel, which maintain tension on medication tray body 104.

In one embodiment, the compartment unlocking operation of solenoid 31 is controlled by the computer that is carried by the cart. A user would be assigned a unique access code to allow solenoid control. The computer could be enabled to track access and unlocking actions by all users, as part of a medication control procedure. Solenoid 31 is driven through a pulse of DC voltage provided over a USB cable from the computer carried by the cart. Once the access code is entered by the user, the pulse is delivered. This pulls the solenoid shut, which unlocks the top cover. After a preset amount of time (which can potentially be selected by the user or whoever sets up the system), which may be from 5 seconds to 5 minutes, another pulse is automatically delivered, which locks the top, if and when it is closed. As shown in FIGS. 6A, 6B and 6C, PC board 37 contains the circuitry and connections for cables that drive solenoid 31. PC board 40 contains status indicating LEDs that indicate battery charge status. Board 40 mounts into enclosure 10.

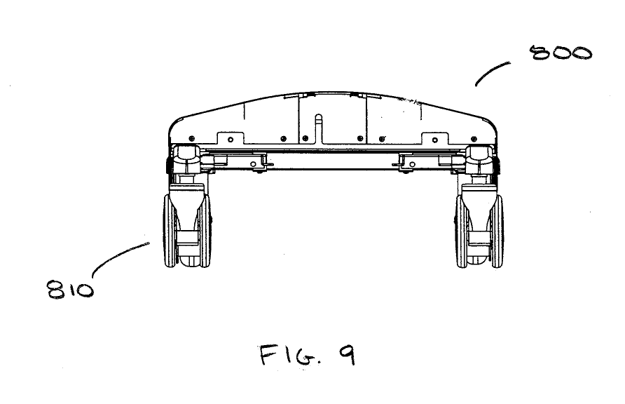

In a preferred embodiment, and as shown in FIGS. 8-15, the mobile cart of the invention may include a base section with four swiveling casters and one or two non-swiveling, self-leveling wheels. With reference to FIGS. 8 and 9, base section 800 includes four omni-directional, locking swiveling casters or wheels 810. Swiveling casters or wheels 810 are preferably four inches in diameter, although alternate configurations, including but not limited to three-inch, six-inch and eight-inch diameter casters are contemplated. Base section 800 also includes cover sections 820a and 820b, although in an alternate embodiment, cover sections 820a and 820b may be combined into a single unit.

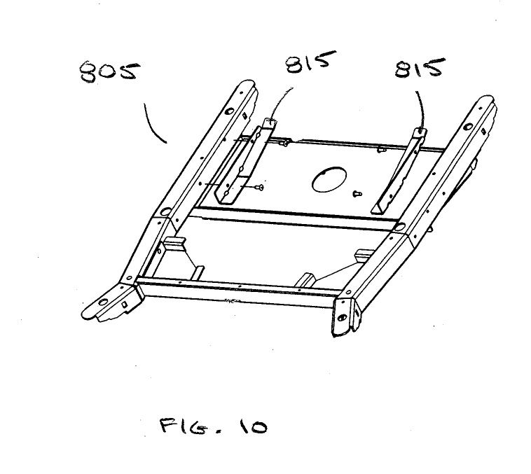

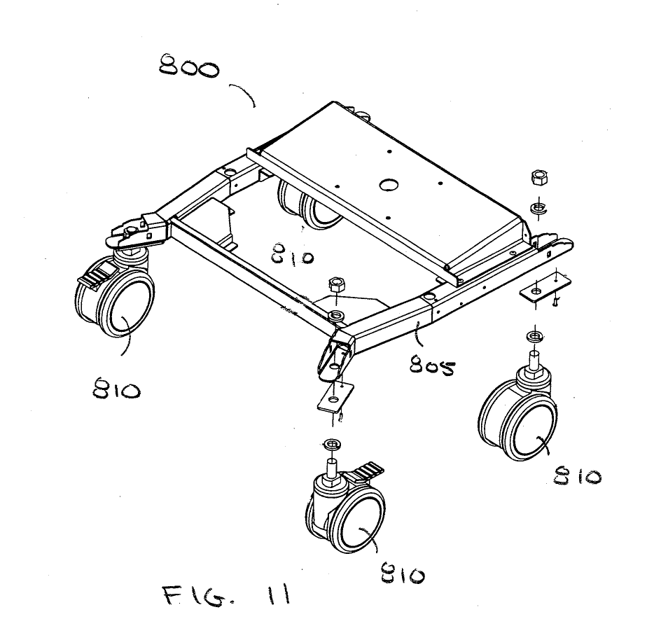

With reference to FIGS. 10 and 11, base section 800 comprises a supporting base frame 805. In a preferred embodiment, base frame 805 is generally rectangular, having a top, a bottom, a front, a back, and two opposing sides. Base frame 805 may also includes brackets 815 for supporting a battery power source carried on the cart.

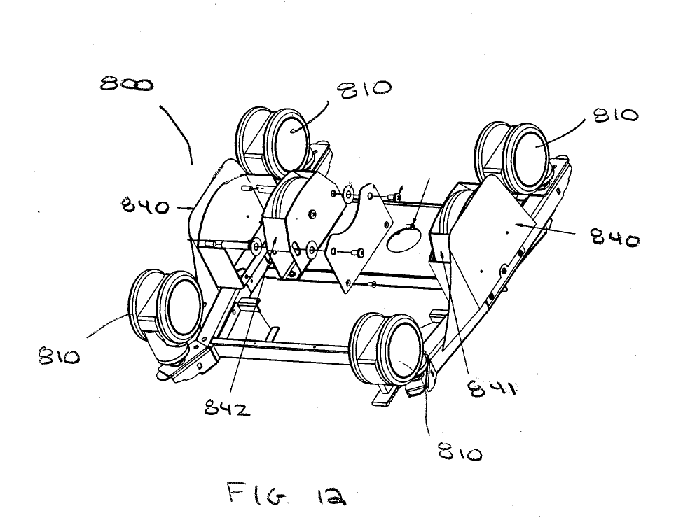

FIG. 12 is a bottom view of base section 800, showing the four omni-directional, locking swiveling casters 810, the left side non-swiveling wheel assembly 841, the right side non-swiveling wheel assembly 842, and the wheel covers 840. The swiveling casters 810 are rotatably mounted to the bottom of base frame 805, proximate each of the four corners of the generally rectangular base frame 805. The non-swiveling wheel assemblies 841 and 842 are also mounted to the bottom of base frame 805, proximate the centers of each of the sides of the base frame 805. In an alternate embodiment, base section 800 may include only one non-swiveling wheel assembly, located proximate the center of one of the sides of base frame 805.

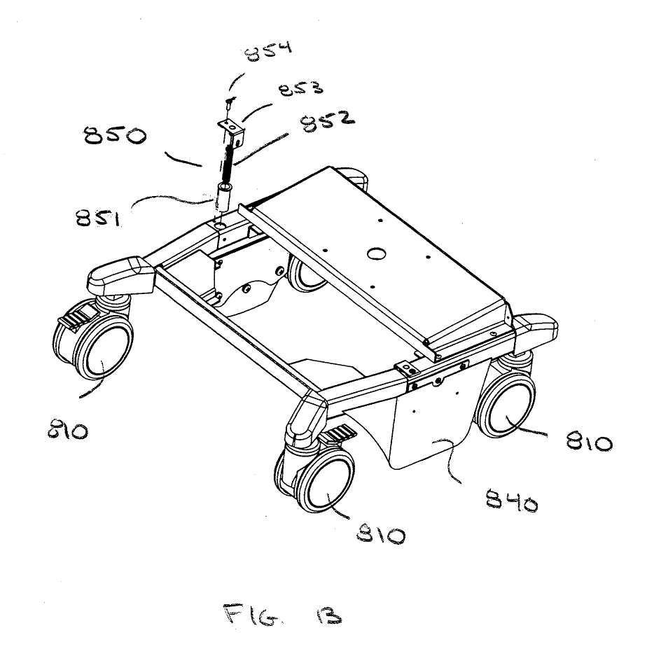

As shown in FIG. 13, a spring assembly 850 is used to exert a slight downward pressure on each of the non-swiveling wheel assemblies 841 and 842, to keep the wheels in contact with the surface of the floor. In a preferred embodiment, each spring assembly 850 comprises a bushing 851, a spring 852, a retainer 853 and a screw 854. Spring 852 is preferably a compression spring, and pushes down on the front end of wheel assemblies 841 and 842, while the rear end of the wheel assemblies pivots, to keep the wheel assemblies 841 and 842 on the floor.

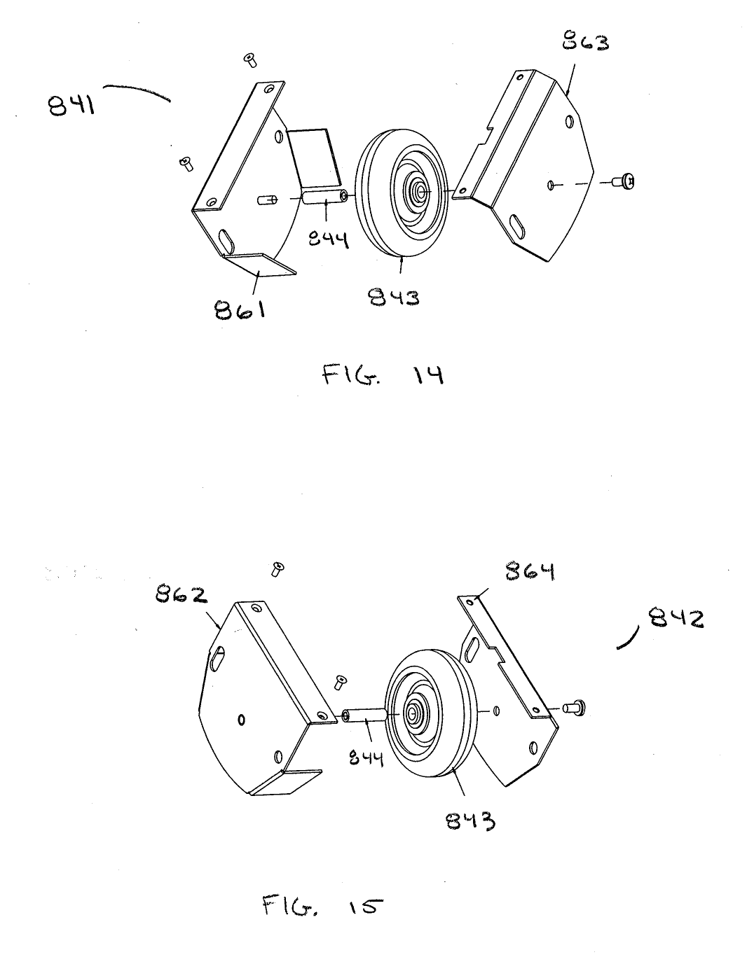

With reference to FIGS. 14 and 15, each wheel assembly 841 and 842 comprises a wheel 843 mounted on a bushing 844. Left side wheel assembly 841 further includes two plate brackets 861 and 863, and right side wheel assembly 842 further includes two plate brackets 862 and 864.

The claims should not be read as limited to the described order or elements unless stated to that effect. Therefore, all embodiments that come within the scope and spirit of the following claims and equivalents thereto are claimed as the invention.

What is claimed:

1. A mobile cart, comprising:
a rolling base section;
an intermediate section that accomplishes a variable length, under user control; and
an upper working section supported by the intermediate section and comprising a secure storage compartment comprising a normally-locked lid that, when unlocked, must be held open by a user, and when released automatically returns to the closed position and locked state.

2. The cart of claim 1 in which the upper working section further comprises an electrically-operated, normally-locked locking mechanism for the lid.

3. The cart of claim 2 in which the locking mechanism is unlocked under computer control.

4. The cart of claim 2, where the locking mechanism comprises a solenoid.

5. The cart of claim 2, where the secure storage compartment further comprises one or more damped cylinders to allow the lid to close gently.

6. The cart of claim 1, where the secure storage compartment comprises a plurality of removable containers.

7. The cart of claim 1, where the intermediate section comprise an adjustable post.

8. The cart of claim 1, where the base section comprises a plurality of swiveling wheels and at least one non-swiveling wheel.

9. The cart of claim 9, where the base section is generally rectangular in shape, and one swiveling wheel is located proximate each of the corners of the base section.

10. The cart of claim 9, where the at least one non-swiveling wheel is located on one side of the base section, between two of the swiveling wheels.

11. The cart of claim 8, where the at least one non-swiveling wheel is self-leveling.

12. The cart of claim 8, further comprising a spring assembly removably coupled to the at least one non-swiveling wheel, to accomplish a self-leveling function.

13. A cart comprising:
a base section having a generally rectangular shape and a bottom, a top, a front, a back, and two opposing sides, and comprising
four swiveling wheels mounted to the bottom of the base section proximate each of the four corners of the base section and two non-swiveling wheels mounted to the bottom of the base section, proximate the centers of the sides of the base section, and
two non-swiveling wheels mounted to the bottom of the base section, each non-swiveling wheel located between two of the swiveling wheels; an intermediate section comprising an adjustable post; and
an upper working section supported by the intermediate section.

14. The cart of claim 12, where the upper working section further comprises a locking compartment.

15. The cart of claim 12, where the upper working section comprises a secure storage compartment comprising a normally-locked lid that, when unlocked, must be held open by a user, and when released automatically returns to the closed position and locked state.

16. The cart of claim 15, where the upper working section further comprises an electrically-operated, normally-locked locking mechanism for the lid.

17. The cart of claim 16, where the locking mechanism is unlocked under computer control.

18. A cart comprising:
a base section having a generally rectangular shape and a bottom, a top, a front, a back, and two opposing sides, and comprising
four swiveling wheels mounted to the bottom of the base section proximate each of the four corners of the base section and two non-swiveling wheels mounted to the bottom of the base section, proximate the centers of the sides of the base section,
two non-swiveling wheels mounted to the bottom of the base section, each non-swiveling wheel located between two of the swiveling wheels, and a spring assembly removably coupled to the each non-swiveling wheel, to accomplish a self-leveling function;
an intermediate section that accomplishes a variable length, under user control; and
an upper working section supported by the intermediate section and comprising a secure storage compartment comprising a normally-locked lid that, when unlocked, must be held open by a user, and when released automatically returns to the closed position and locked state, where the locking mechanism is under computer control, and one or more damped cylinders to allow the lid to close gently.

19. The cart of claim 18, where the upper working section further comprises an electrically-operated locking mechanism.

20. The cart of claim 18, where the locking mechanism is unlocked under computer control.
